(19) United States
(12) Patent Application Publication
(10) Pub. No.: US 2025/0262977 A1
(43) Pub. Date: Aug. 21, 2025

(54) POWER SOURCE EXCHANGE SYSTEM AND METHOD OF EXCHANGING A POWER SOURCE

(71) Applicant: Ocado Innovation Limited, Hatfield (GB)

(72) Inventor: Caner BINGOL, Hatfield (GB)

(21) Appl. No.: 19/204,322

(22) Filed: May 9, 2025

Related U.S. Application Data
(63) Continuation of application No. PCT/EP2023/081199, filed on Nov. 8, 2023.

(30) Foreign Application Priority Data
Nov. 11, 2022 (GB) 2216843.9

(51) Int. Cl. B60L 53/80; B66F 9/075

(52) U.S. Cl. CPC B60L 53/80; B66F 9/07504; B66F 9/0754; B60L 2200/44

(57) ABSTRACT

The present disclosure relates to a power source exchange system and a method for exchanging a power source. The power source exchange system comprises a compartment configured to removably receive a power source, a rotatable end effector, and a locking assembly. Rotation of the end effector can move the locking member from the locked position to the unlocked position. A load handling device is provided for lifting and moving containers arranged in stacks in a storage structure. The load handling device comprises the compartment, and a power source received into the compartment is configured to deliver electrical power to the load handling device. A storage and retrieval system is provided, comprising the storage structure, load handling device, and power source exchange system. Methods are provided of inserting a power source into the compartment of the power source exchange system, removing a power source, and exchanging a power source.

### CROSS-REFERENCE TO RELATED APPLICATIONS

This Application is a continuation of PCT International Patent Application No. PCT/EP2023/081199, filed on Nov. 8, 2023, which claims priority to UK Patent Application No. GB2216843.9, filed Nov. 11, 2022, the entire contents of each of which are hereby incorporated by reference.

### TECHNICAL FIELD

The present invention relates to a power source exchange system and a method for exchanging a power source.

### BACKGROUND

Some commercial and industrial activities require systems that enable the storage and retrieval of a large number of different products. WO2015019055A1 describes a storage and retrieval system in which stacks of storage containers are arranged within a grid storage structure. The system further comprises remotely operated load handling devices configured to move on tracks located on the top of the grid storage structure. To access the containers in the grid storage structure, the load handling devices are equipped with a container-holding device for releasably gripping a container at the top of a stack and a lifting mechanism for raising and lowering the container.

Each load handling device is powered by a rechargeable battery. The rechargeable battery is typically charged in situ by driving a load handling device to a charging station located at the edge of the grid storage structure. The load handling device remains stationary at the charging station while the battery is recharged. The charging period is a significant source of downtime for the load handling device and can be on the order of hours.

To alleviate the problem of charging downtime, the load handling device may be powered by an exchangeable battery. When the battery in the load handling device is depleted, the depleted battery is exchanged for a fully charged battery and therefore the charging downtime is reduced to the time it takes to exchange the battery, rather than being the time to charge the battery.

A load handling device may encounter bumps, vibrations or even crashes when operating on the tracks of the grid storage structure. For a load handling device powered by an exchangeable battery, it is desirable for the battery to be securely held within the load handling device. It is also desirable to provide an efficient and automated system for exchanging a battery in the load handling device.

### SUMMARY

The invention is defined in the accompanying claims.

The invention provides a power source exchange system comprising: a compartment configured to removably receive a power source; an end effector rotatable between an engaged position for engagement with the power source in order to move the power source into and out of the compartment, and a release position; and a locking assembly comprising a locking member movable between a locked position for blocking removal of the power source from the compartment and an unlocked position for enabling removal of the power source from the compartment, wherein the end effector and locking assembly are configured such that rotation of the end effector from the release position to the engaged position causes the end effector to move the locking member from the locked position to the unlocked position.

The invention thus provides a system in which an exchangeable power source can be securely locked in a compartment and in which an end effector can be used to unlock and remove power source in an efficient and automated manner. The end effector is only required to perform a simple rotational movement to simultaneously unlock the power source and be in a position for engaging the power source to remove the power source from the compartment.

In the release position, the end effector may be disengaged from the power source to allow the end effector to move away from the power source, e.g. in a direction parallel to an insertion direction in which the power source is inserted into the compartment.

The compartment may comprise the locking member. The compartment may define a power-source-receiving space for receiving the power source and the locking member may be configured to overhang the power-source-receiving space in the locked position in order to block removal of the power source from the compartment. In other words, when the power source is within the compartment, the locking member protrudes over the power source to block removal of the power source. The end effector may be configured such that when the end effector is in the engaged position, the end effector extends past the power-source-receiving space to enable the end effector to move the locking member to the unlocked position. The locking member may comprise a tapered surface configured such that movement of the power source into the compartment moves the locking member from the locked position to the unlocked position to allow the power source to be received into the compartment.

The power source exchange system may further comprise a power source.

The power source may comprise the locking member. The compartment may be configured to engage with the locking member when the locking member is in the locked position in order to block removal of the power source from the compartment. For example, the compartment may comprise a blocking member configured to engage with the locking member when the locking member is in the locked position in order to block removal of the power source from the compartment. The power source may comprise an end wall exposed to the end effector when the power source is within the compartment. The end wall may be oriented perpendicular to an insertion direction in which the power source is received into the compartment. The locking member may be mounted on the end wall.

The power source may comprise one or more handling members. Each handling member may be configured to receive a respective portion of the end effector when the end effector is rotated from the release position to the engaged position. The respective portions of the end effector may be received by each handling member in a circumferential direction. Each handling member may be further configured to engage the respective portion of the end effector to enable the end effector to move the power source into and out of the compartment. Each handling member may engage the respective portion of the end effector in a direction parallel to an insertion direction in which the power source is received into the compartment. In the release position, the respective portions of the end effector may exit the handling members (move away from the handling members in a circumferential direction) such that the end effector can no longer engage the handing members in a direction parallel to an insertion direction in which the power source is received into the compartment. The power source may comprise an end wall exposed to the end effector when the power source is within the compartment. The end wall may be oriented perpendicular to the insertion direction. The one or more handling members may be mounted on the end wall.

The power source may comprise a plurality of handling members and the plurality of handling members may be arranged at different angular positions about a longitudinal axis, i.e. they are spaced in the circumferential direction about a longitudinal axis. The longitudinal axis may be an axis orientated parallel to the insertion direction when the power source is received into the compartment. The plurality of handling members may be spaced at substantially equal angular intervals about the longitudinal axis, i.e. the interval between the angular positions of the handling members may be substantially equal. The handling members may be arranged in substantially the same plane. The plane may be orientated substantially perpendicular to the longitudinal axis. The handling members may be configured to receive respective portions of the end effector in the same circumferential direction. The power source may comprise at least one pair of handling members diametrically opposed about the longitudinal axis. The power source may comprise four handling members arranged at 90 degree intervals about the longitudinal axis.

The power source may be a battery. The battery may be a rechargeable battery.

The power source compartment may be configured to electrically couple to the power source (automatically) when the power source is received in the compartment. The power source may comprise an electrical connector and the compartment may comprise a corresponding electrical connector. The electrical connector of the power source and the corresponding electrical connector of the compartment may be configured to electrically couple (automatically) when the power source is received into the compartment.

The locking assembly may further comprise biasing means configured to apply a biasing force for biasing the locking member to the locked position. The end effector and the locking assembly may be further configured such that rotation of the end effector from the engaged position to the release position allows the biasing force to return the locking member to the locked position. The end effector may be disengaged from the locking member in the release position. The biasing means may be a spring, e.g. a torsion spring, a compression spring or an extension spring. The end effector is therefore only required to perform a simple rotational movement to simultaneously release and lock the power source in the compartment.

The end effector and the locking assembly may be configured such that when the end effector is in the engaged position, the locking member is held in the unlocked position by the end effector.

The locking member may be linearly movable between the locked position and the unlocked position. The locking member may be linearly movable between the locked position and the unlocked position in a direction substantially perpendicular to an insertion direction in which the power source is received into the compartment. Alternatively, the locking member may be pivotally mounted for rotation between the locked position and the unlocked position. The pivot axis may be orientated parallel to the insertion direction. The pivot axis may be orientated perpendicular to the insertion direction.

The locking assembly may comprise a plurality of locking members. The locking assembly and the end effector may be configured such that rotation of the end effector from the release position to the engaged position causes the end effector to move each locking member from the locked position to the unlocked position.

The plurality of locking members may be arranged at different angular positions about a longitudinal axis, i.e. they are spaced in the circumferential direction about a longitudinal axis. The longitudinal axis may be an axis orientated parallel to the insertion direction when the power source is received into the compartment. The plurality of locking members may be spaced at substantially equal angular intervals about the longitudinal axis, i.e. the interval between the angular positions of the locking members may be substantially equal. The locking members may be arranged in substantially the same plane. The plane may be orientated substantially perpendicular to the longitudinal axis. The longitudinal axis may be an axis orientated parallel to the insertion direction when the power source is received into the compartment. The locking assembly may comprise at least one pair of locking members diametrically opposed about the longitudinal axis. The locking assembly may comprise four locking members arranged at 90 degree intervals about the longitudinal axis. In the case where the power source also comprises a plurality of handling members, the angular positions of at least a subset of the handling members and the angular positions of at least a subset of the locking members may be substantially the same with respect to a common longitudinal axis.

The end effector may comprise a plurality of engagement members. In the case where the locking assembly comprises a plurality of locking members, the engagement members may be arranged such that when the end effector is rotated from the release position to the engaged position about a rotational axis, each particular engagement member moves to a position for engagement with the power source and/or moves one of the locking members from the locked position to the unlocked position. In the case where the power source comprises a plurality of handling members and a plurality of locking members, the engagement members may be arranged such that when the end effector is rotated from the release position to the engaged position, each particular engagement member is received by one of the handling members and/or moves one of the locking members from the locked position to the unlocked position. When the end effector is in the release position, the angular positions of the engagement members may be between the angular positions of the locking members and between the angular positions of the handling members with respect to a common longitudinal axis. Put another way, the engagement members may lie between the handling members and between the locking members in a circumferential direction with respect to a common longitudinal axis.

The engagement members may be positionally fixed with respect to each other. In other words, the engagement members may not be movable relative to each other. The engagement members may extend in a radial direction with respect to the rotational axis. The engagement members may be arranged substantially in a plane orientated perpendicular to the rotational axis. The engagement members may be arranged at different angular positions about the rotational axis, i.e. they are spaced in the circumferential direction about a longitudinal axis. The engagement members may be spaced at substantially equal angular intervals about the rotational axis, i.e. the interval between the angular positions of the engagement members may be substantially equal. The end effector may comprise at least one pair of engagement members extending in opposite radial directions with respect to the rotational axis. The end effector may comprise four engagement members arranged at 90 degree intervals about the rotational axis to form a substantially cruciform shape. In this case, the power source may comprise four handling members arranged at 90 degree intervals about a longitudinal axis and/or the locking assembly may comprise four locking members arranged at 90 degree intervals about a longitudinal axis. In another example, the power source may comprise four handling members arranged at 90 degree intervals about a longitudinal axis and the locking assembly may comprise a pair of locking members diametrically opposed about a longitudinal axis. In another example, the power source may comprise a pair of handling members diametrically opposed about a longitudinal axis and the locking assembly may comprise four locking members arranged at 90 degree intervals about a longitudinal axis.

The end effector may be configured such that a rotational axis of the end effector is orientated parallel to the insertion direction of the power source when rotating between the engaged and release positions. The rotational axis may be concentric with the longitudinal axis about which the handling members and/or the locking members are arranged when rotating between the engaged and release positions.

The compartment may be configured to receive the power source in a downwards direction.

The compartment may be configured to receive the power source in a horizontal direction.

The end effector may be mounted on a robotic arm configured to move and rotate the end effector between the engaged position and the release position. The robotic arm may, for example, be a gantry robot, a Cartesian robot or an articulated robot.

The power source exchange system may further comprise a power source station. The power source station may comprise a plurality of power source bays, each power source bay being configured to receive the power source. The end effector may be further configured to move the power source between the compartment and any of the power source bays of the power source station. Each power source bay may be configured to charge the power source once received in the power source bay.

The power source exchange system may further comprise a device. The device may comprise the compartment and one or more electrical and/or electronic components. The compartment may be configured to deliver power from the power source to the one or more electrical and/or electronic components once the power source is received into the compartment.

The power source exchange system may further comprise a load handling device for lifting and moving containers arranged in stacks in a storage structure. The storage structure may comprise a track structure. The track structure may comprise a first set of tracks and a second set of tracks. The first set of tracks may extend in a first direction and the second set of tracks may extend in a second direction. The second direction may be substantially perpendicular to the first direction, to form a grid pattern defining a plurality of grid cells above the stacks of containers. The load handling device may comprise: a driving assembly configured to move the load handling device on the track structure; a container-holding device configured to releasably hold a container from above; and a lifting mechanism configured to raise and lower the container-holding device.

The load handling device may further comprise the compartment. The compartment may be configured to deliver electrical power to one or more electrical or electronic components of the load handling device once the power source is received into the compartment. The one or more electrical and/or electronic components may include one or more of: the driving assembly, the container-holding device and the lifting mechanism.

The compartment may be externally exposed such that the compartment is externally accessible to the end effector to allow the end effector to move the power source into and out of the compartment. The compartment may be located at least partially within an external body of the load handling device. The compartment may extend out of the external body of the load handling device.

The present invention also provides a storage and retrieval system comprising: a storage structure comprising: a track structure, the track structure comprising a first set of tracks and a second set of tracks, the first set of tracks extending in a first direction and the second set of tracks extending in a second direction, the second direction being substantially perpendicular to the first direction, to form a grid pattern defining a plurality of grid cells; and a plurality of upright members configured to support the track structure from below to define a storage area below the track structure for storing a plurality of stacks of containers below each grid cell; and wherein the storage and retrieval system further comprises the power source exchange system as defined above.

The end effector may be mounted on a robotic arm located on, or above, or adjacent to the track structure such that the end effector can move a power source into and out of the compartment of a load handling device located on the track structure.

The present invention also provides a method of inserting the power source into the compartment of the power source exchange system or storage and retrieval system defined above. The method comprises the steps of: moving the power source into the compartment using the end effector in the engaged position; and rotating the end effector from the engaged position to the release position.

The present invention also provides a method of removing the power source from the compartment of the power source exchange system or storage and retrieval system defined above. The method comprises the steps of: rotating the end effector from the release position to the engaged position; and moving the power source out of the compartment using the end effector.

The present invention also provides a method of exchanging a first power source for a second power source in the compartment of the power source exchange system as defined above. The method comprises the steps of: rotating the end effector from the release position to the engaged position; moving the first power source out of the compartment using the end effector; inserting the second power source into the compartment using the end effector in the engaged position; and rotating the end effector from the engaged position to the release position.

The second power source may have a higher charge level than the first power source at the point when the first power source is moved out of the compartment.

### DESCRIPTION OF THE DRAWINGS

The present invention will now be described, by way of example only, with reference to the accompanying drawings, in which:

FIG. 1 is a schematic perspective view of a grid storage structure and containers arranged within the grid storage structure.

FIG. 2 is a schematic plan view of a track structure on top of the storage structure of FIG. 1.

FIG. 3 shows load handling devices on top of the track structure of the storage structure of FIG. 1.

FIG. 4 is a schematic perspective view of a load handling device with a container-holding device in a position below the bottom of the load handling device.

FIG. 5 is a schematic perspective view of the load handling device of FIG. 4 with a side panel removed to show a container-receiving space.

FIG. 6 is a schematic perspective view of the load handling device of FIG. 5 with a container occupying the container-receiving space.

FIG. 7 is a schematic perspective view of the load handling device of FIG. 6 showing an example location for a power source compartment.

FIG. 8 is a schematic perspective view of an alternative external body for the load handling device of FIG. 4, comprising corner blocks together connected by connecting elements to form an open frame structure.

FIG. 9 is an exploded view of a first power source exchange system comprising a power source compartment, a power source and an end effector.

FIG. 10 is a perspective view of the power source of the first power source exchange system.

FIG. 11A is a perspective view of the power source and the end effector of the first power source exchange system showing the end effector in a release position. FIG. 11B shows the end effector in an engaged position.

FIG. 12 is a perspective view of the power source compartment of the first power source exchange system.

FIG. 13A is a schematic cross-sectional view of the power source and the power source compartment of the first power source exchange system showing the power source in the power source compartment with locking members in a locked position.

FIG. 13B shows the locking members in an unlocked position.

FIG. 14A is a perspective view of the power source, power source compartment and end effector of the first power source exchange system showing the power source in the power source compartment with the locking members in the locked position and the end effector in the release position.

FIG. 14B is a top view of the system shown in FIG. 14A.

FIG. 15A is a perspective view of the power source, power source compartment and end effector of the first power source exchange system showing the power source in the power source compartment with the locking members in the unlocked position and the end effector in the engaged position.

FIG. 15B is a top view of the system shown in FIG. 15A.

FIGS. 16A-16D is a sequence showing how the power source is unlocked and removed from the power source compartment using the end effector in the first power source exchange system.

FIG. 17 is an exploded view of a second power source exchange system comprising a power source compartment, a power source and an end effector.

FIG. 18 is a close-up view of a locking member of the second power source exchange system.

FIG. 19A is a perspective view of the power source, power source compartment and end effector of the second power source exchange system showing the power source in the power source compartment with the locking members in a locked position and the end effector in a release position.

FIG. 19B is a top view of the system shown in FIG. 19A.

FIG. 20A is a perspective view of the power source, power source compartment and end effector of the second power source exchange system showing the power source in the power source compartment with the locking members in an unlocked position and the end effector in an engaged position.

FIG. 20B is a top view of the system shown in FIG. 20A.

FIG. 21 is an exploded view of a third power source exchange system comprising a power source compartment, a power source and an end effector.

FIG. 22A is an exploded view of an assembly comprising a handling member, a locking member and a guide.

FIG. 22B shows the exploded assembly of FIG. 22A from below.

FIG. 23A is a perspective view of the power source, power source compartment and end effector of the second power source exchange system showing the power source in the power source compartment with the locking members in a locked position and the end effector in a release position.

FIG. 23B is a top view of the system shown in FIG. 23A.

FIG. 24A is a perspective view of the power source, power source compartment and end effector of the second power source exchange system showing the power source in the power source compartment with the locking members in an unlocked position and the end effector in an engaged position.

FIG. 24B is a top view of the system shown in FIG. 24A.

FIG. 25 is a schematic perspective view of a power source station.

FIG. 26 is a schematic perspective view of a first example robotic arm operating above the track structure of the grid storage structure shown in FIG. 1.

FIG. 27 is a schematic perspective view of a second example robotic arm operating adjacent to the track structure of the grid storage structure shown in FIG. 1.

### DETAILED DESCRIPTION

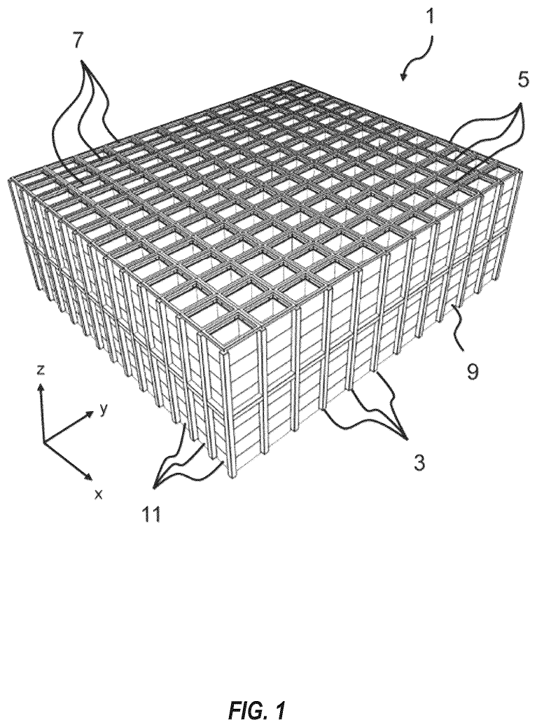

FIG. 1 shows an example storage structure 1 that may be used in a storage and retrieval system to store storage containers 9. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of storage containers 9 per grid cell 14.

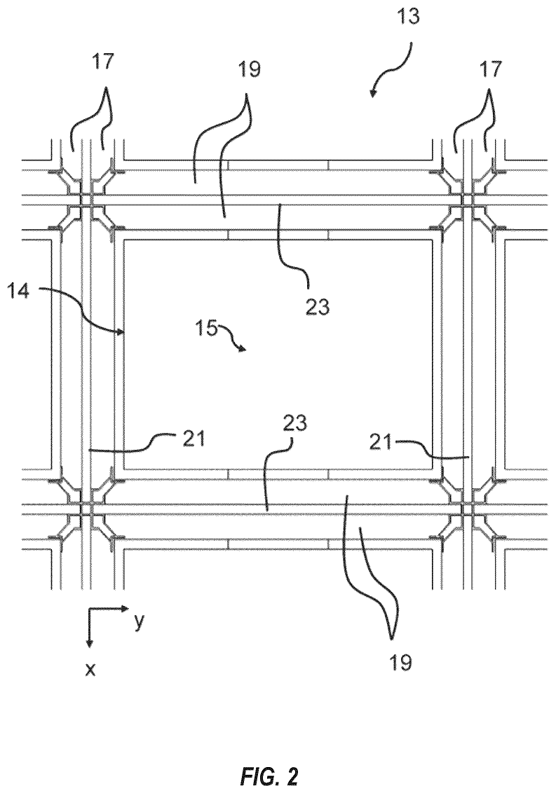

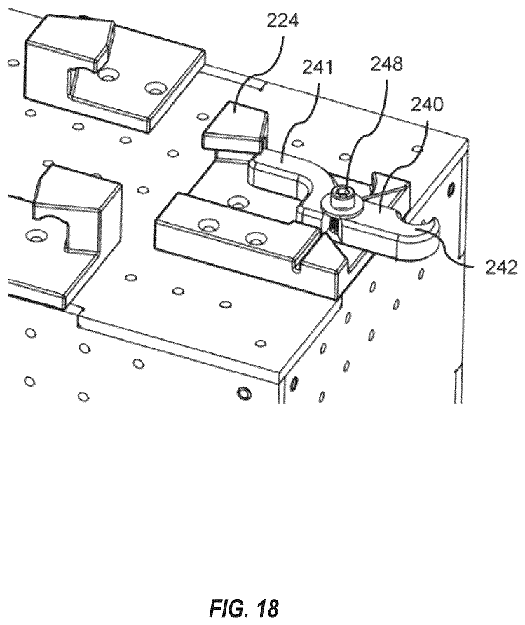

FIG. 2 shows a large-scale plan view of a section of track structure 13 forming part of the storage structure 1 illustrated in FIG. 1 and located on top of the horizontal members 5, 7 of the storage structure 1 illustrated in FIG. 18. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centers of the grid cells 14. The apertures 15 are sized to allow storage containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

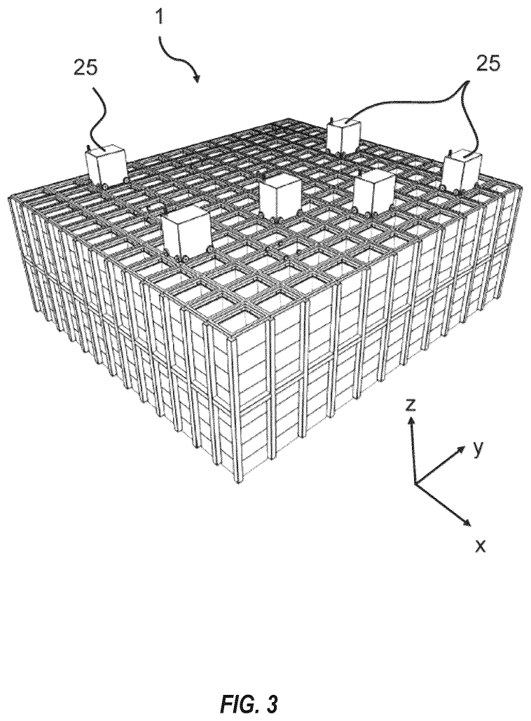

FIG. 3 shows a plurality of load handling devices 25 moving on top of the storage structure 1 illustrated in FIG. 18. The load handling devices 25, hereinafter referred to as “bots”, are provided with sets of wheels to engage with corresponding x-or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighboring grid cells 14 without colliding with one another.

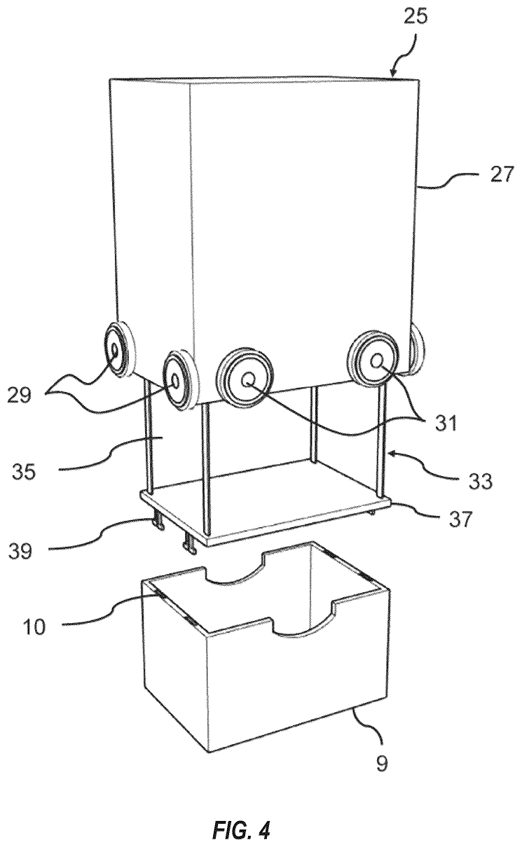

As illustrated in FIG. 4, a bot 25 comprises an external body 27 in or on which are mounted one or more components which enable the bot 25 to perform its intended functions. These functions may include moving across the storage structure 1 on the track structure 13 and raising or lowering storage containers 9 (e.g. from or to stacks 11) so that the bot 25 can retrieve or deposit storage containers 9 in specific locations defined by the grid pattern.

The illustrated bot 25 comprises a driving assembly comprising first and second sets of wheels 29, 31 which are mounted on the external body 27 of the bot 25 and enable the bot 25 to move in the x-and y-directions along the tracks 17 and 19, respectively. In particular, two wheels 29 are provided on the shorter side of the bot 25 visible in FIG. 4, and a further two wheels 29 are provided on the opposite shorter side of the bot 25. The wheels 29 engage with tracks 17 and are rotatably mounted on the external body 27 of the bot 25 to allow the bot 25 to move along the tracks 17. Analogously, two wheels 31 are provided on the longer side of the bot 25 visible in FIG. 4, and a further two wheels 31 are provided on the opposite longer side of the bot 25. The wheels 31 engage with tracks 19 and are rotatably mounted on the external body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the external body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the external body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the external body 27 of the bot 25 stays substantially at the same height and therefore the weight of the external body 27 and the components mounted thereon does not need to be lifted and lowered by the wheel-positioning mechanism.

The bot 25 also comprises a lifting mechanism 33 and a container-holding device 37 configured to raise and lower storage containers 9. The illustrated lifting mechanism 33 comprises four tethers 35 which are connected at their lower ends to the container-holding device 37. The tethers 35 may be in the form of cables, ropes, tapes, or any other form of tether with the necessary physical properties to lift the storage containers 9. The container-holding device 37 comprises a gripping mechanism 39 configured to engage with features of the storage containers 9 to releasably hold the containers 9 from above. In the illustrated example, the gripping mechanism 39 comprises legs that can be received in corresponding apertures 10 in the rim of the storage container 9 and then moved outwards to engage with the underside of the rim of the storage container 9. The tethers 35 can be wound up or down to raise or lower the container-holding device 37 as required. One or more motors and winches or other means may be provided to effect or control the winding up or down of the tethers 35.

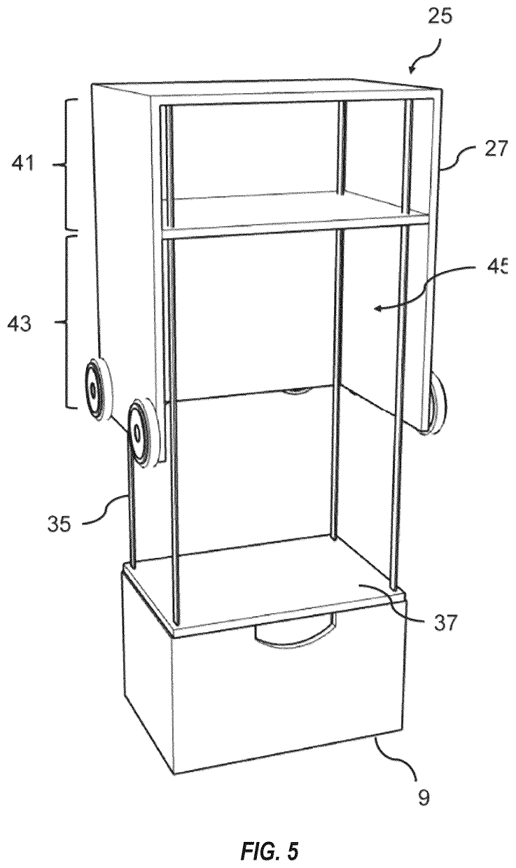

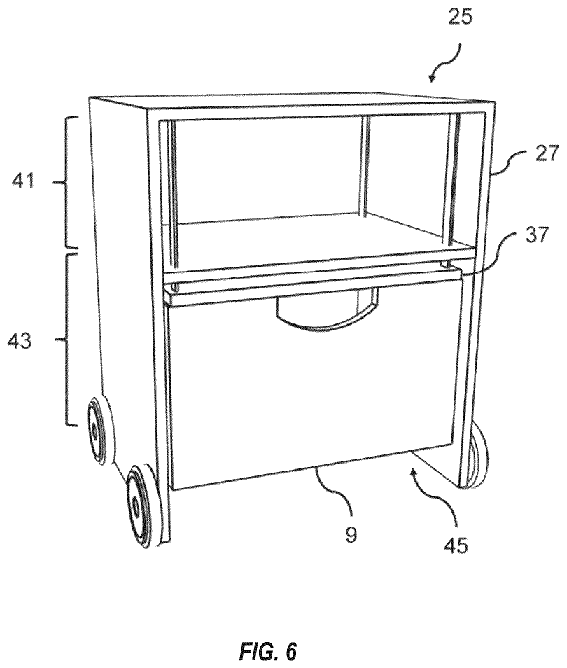

In FIG. 5 and FIG. 6, a side portion of the external body 27 of the bot 25 has been omitted from view to allow the interior of the bot 25 to be seen. The external body 27 of the illustrated bot 25 has an upper portion 41 and a lower portion 43. The upper portion 41 is configured to house or support one or more operation components (not shown), such as components of the lifting mechanism 33 (e.g. motors), wireless communication components, one or more processors for controlling operation of the bot 25, etc. The lower portion 43 is arranged beneath the upper portion 41. The lower portion 43 is externally open at the bottom and defines a container-receiving space 45 for accommodating at least part of a storage container 9 that has been raised into the container-receiving space 45 by the lifting mechanism 33. FIG. 5 shows the container-receiving space 45 before it is occupied by a storage container 9 and FIG. 6 shows the container-receiving space 45 after it has been occupied by a storage container 9. The container-receiving space 45 is sized such that enough of a storage container 9 can fit inside the space 45 to enable the bot 25 to move across the track structure 13 on top of storage structure 1 without the underside of the storage container 9 catching on the track structure 13 or another part of the storage structure 1. When the bot 25 has reached its intended destination, the lifting mechanism 33 controls the tethers 35 to lower the container-holding device 37 and the corresponding storage container 9 out of the space 45 and into the intended position. The intended position may be a stack 11 of storage containers 9 or an egress point of the storage structure 1 (or an ingress point of the storage structure 1 if the bot 25 has moved to collect a storage container 9 for storage in the storage structure 1). Although in the illustrated example the upper and lower portions 41, 43 are separated by a physical divider, in other examples, the upper and lower portions 41, 43 may not be physically divided by a specific component or part of the external body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the external body 27 of the bot 25. For example, the container-receiving space 49 may instead be adjacent to the external body 27 of the bot 25, e.g. in a cantilever arrangement with the weight of the external body 27 of the bot 25 counterbalancing the weight of the container 9 to be lifted. In such embodiments, a frame or arms of the lifting mechanism 33 may protrude horizontally from the external body 27 of the bot 25, and the tethers 35 may be arranged at respective locations on the protruding frame/arms and configured to be raised and lowered from those locations to raise and lower a storage container 9 into the container-receiving space 45 adjacent to the external body 27.

The bot 25 is powered by a power source (e.g. a battery) which is received into a power source compartment. The power source and power source compartment are configured to electrically couple to each other (e.g. by providing electrical connectors on the power source and in the power source compartment). Once coupled, electrical power is delivered from the power source to one or more electrical or electronic components of the bot 25, such as the driving assembly, the lifting mechanism 33 and/or the container-holding device 37.

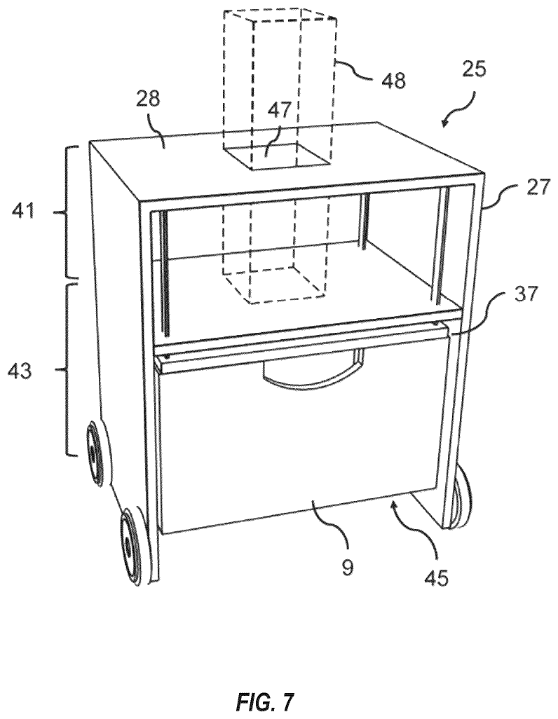

FIG. 7 shows the bot 25 with a region 48 demarcated with dotted lines. The power source compartment may be located anywhere within the region 48. For example, the power source compartment may be located fully within the external body 27 of the bot 25, or the power source compartment may extend through the top side 28 of the external body 27 of the bot 25, or the power source compartment may be fully located above the external body 27 of the bot 25.

In this example, the power source compartment is configured to receive the power source in a downwards direction. The compartment is also externally exposed such that the power source compartment is externally accessible from a location above the external body 27 of the bot 25. The top side 28 of the external body 27 of the bot 25 in FIG. 7 comprises an opening 47. In the case where the compartment is fully within the external body 27 of the bot 25, the opening 47 may be in communication a top opening of the power source compartment so that a power source can be directly inserted into the power source compartment via the opening 47 from a location above the top side 28 of the external body 27 of the bot 25, and directly removed from the power source compartment via the opening 47 to a location above the top side 28 of the external body 27 of the bot 25. In the case where the power source compartment extends through the top side 28 of the external body 27 of the bot 25, the power source compartment may extend through the opening 47. In the case where the power source compartment is fully located above the external body 27 of the bot 25, the power source compartment may be mounted on top side 28 of the external body 27 of the bot 25 and the opening 47 may not be required.

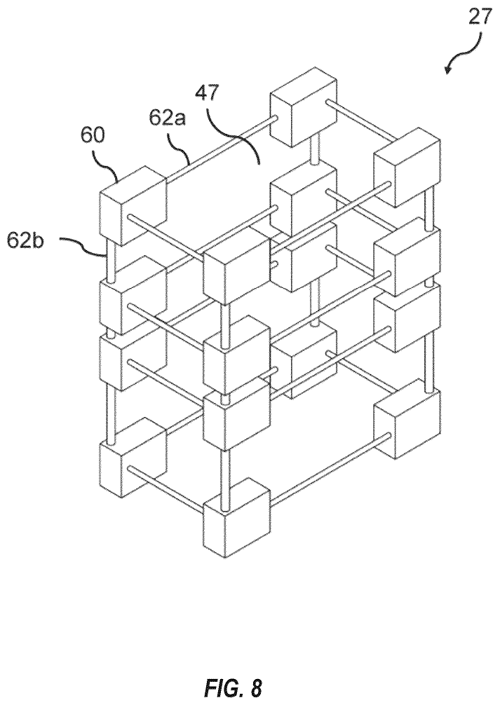

The external body 27 of the bot 25 illustrated in FIG. 4 is defined by a top panel and side panels. FIG. 8 shows another example of the external body 27 of the bot 25 which is defined by corner blocks 60 connected by horizontal connecting elements 62a and vertical connecting elements 62b (e.g. rods) to form an open frame structure. The open frame structure can be used to house and/or support components of the bot 25, such as the driving assembly and the lifting mechanism 33. Due to the open frame structure of the external body, the top side of the external body 27 has an opening 47 formed by the corner blocks 60 and the horizontal connecting elements 62a on the top side of the bot 25. Similar to the bot 25 shown in FIG. 7, the power source compartment can be fully located within the external body 27 of the bot 25 and communicate with the opening 47, or can extend through of the opening 47 of the external body 27 of the bot 25, or can be fully located above the external body 27 of the bot 25.

The power source compartment of the bot 25 forms part of a power source exchange system in which the power source can be inserted into the power source compartment, removed from the power source compartment, or exchanged with another power source in an automated manner using an end effector. Several example power source exchange systems are described below. For conciseness, the power source compartment will be referred to simply as a “compartment” in the following description.

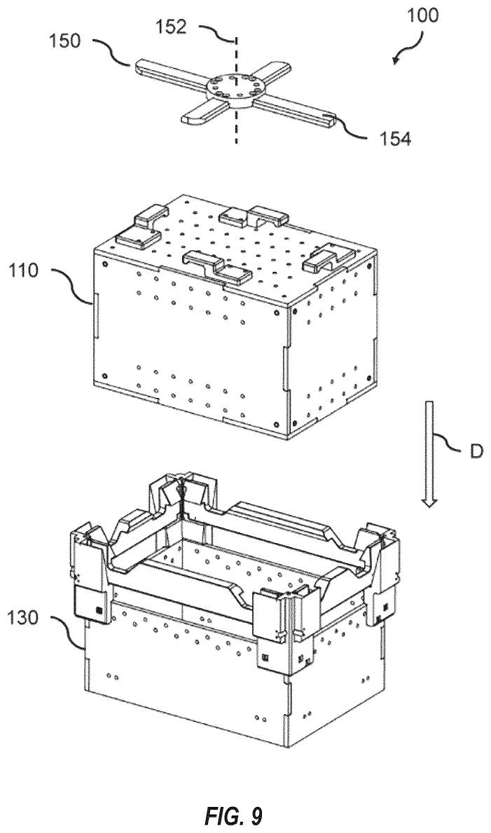

FIG. 9 shows an exploded view of a first power source exchange system 100 comprising a power source 110, a compartment 130 configured to removably receive the power source 110, and an end effector 150 for moving the power source 110 into and out of the compartment 130. The compartment 130 is configured to receive the power source 110 in an insertion direction D, which in this example is a downwards direction. The power source 110 can therefore be removed from the compartment 130 in an upwards direction.

The power source 110 may be a battery or any other suitable form of encased power source for providing electrical power, e.g. a supercapacitor. The power source 110 may be a rechargeable power source, e.g. a rechargeable battery.

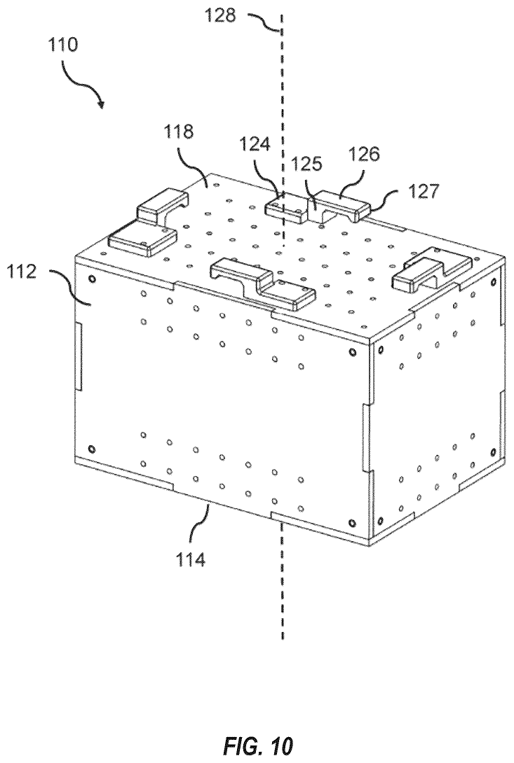

FIG. 10 shows the power source 110 in insolation. The power source 110 comprises an outer casing 112. The outer casing 112 comprises a base 114 and an end wall 118 at opposite ends of the outer casing 112, and sidewalls extending between the base 114 and the end wall 118 to define a substantially cuboidal shape. The base 114 refers to the wall of the outer casing 112 which faces the base 132 of the compartment 130 (i.e. faces downwards) when the power source 110 is orientated for insertion into the compartment 130 and the end wall 118 refers to the wall of the outer casing 112 which faces away from the base 132 of the compartment 130 (i.e. faces upwards) when the power source 110 is orientated for insertion into the compartment 130. The end wall 118 is exposed to the end effector 150 when the power source 110 is within the compartment 130.

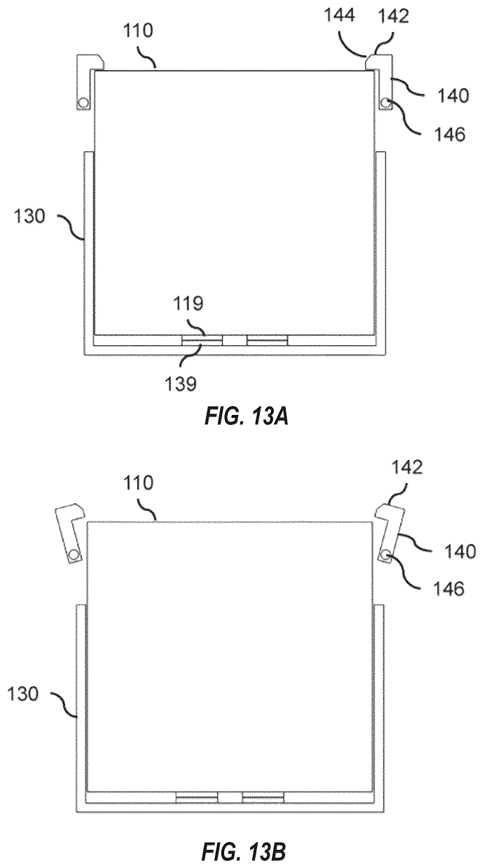

The power source 110 further comprises one or more electrical connectors 119 configured to electrically couple to corresponding electrical connectors 139 of the compartment 130 such that electrical power from the power source 110 can be delivered to any electrical and/or electronic components connected (directly or indirectly) to the electrical connectors of the compartment 130. The electrical connectors 119 of the power source 110 and the electrical connectors 139 of the compartment are arranged such that inserting the power source 110 into the compartment 130 causes the electrical connectors of the power source and the compartment 119, 139 to electrically couple to each other automatically. For example, the electrical connectors 119 of the power source 110 and the corresponding electrical connectors of the compartment 130 may face in opposing directions when the power source 110 is orientated for insertion into the compartment 130 such that the electrical connectors 119, 139 are coupled together when the power source 110 is fully inserted. The electrical connectors 119, 139 may be in the form of any suitable connectors, e.g. male and female connectors (e.g. pins and sockets), electrical contacts, etc. An example arrangement of electrical connectors 119, 139 is shown in FIG. 13A in which a downwards-facing electrical connector 119 is provided on the base 114 of the power source 110 and an upwards-facing electrical connector 139 is provided on the base 132 of the compartment 130.

The power source 110 further comprises handling members 124 mounted on the end wall 118 for engaging with the end effector 150 to allow the end effector 150 to move the power source 110 into and out of the compartment 130. In this example, each handling member 140 comprises a support portion 125 extending upwards from the end wall 118 and a retention portion 126 extending perpendicular to the support portion 125 such that the retention portion 126 overhangs the end wall 118 of the power source 110 and defines a vertical space between the end wall 118 and the retention portion 126. The handling members 140 are distributed evenly at 90 degree intervals about a longitudinal axis 128 extending through the end wall 118 and the base 114 of the power source 110. Furthermore, the retention portions 126 all point (i.e. extend away from their respective support portions 125) in the same circumferential direction with respect to the longitudinal axis 128 (i.e. the retention portions 126 all point clockwise or all point anti-clockwise).

Referring back to FIG. 9, the end effector 150 comprises four engagement members 154 extending radially away from a rotational axis 152 about which the end effector 150 can rotate. The engagement members 154 lie in a plane perpendicular to the rotational axis 152 and are spaced evenly about the rotational axis 152 at 90 degree intervals to define a substantially cruciform shape.

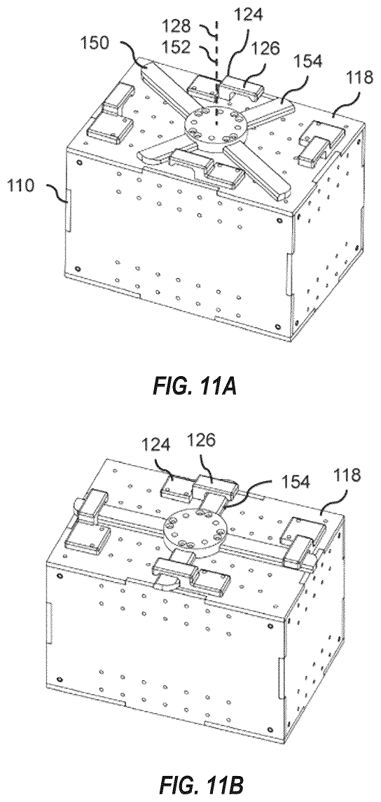

FIG. 11A shows the power source 110 and the end effector 150 when the end effector 150 is in a release position above the end wall 118 of the power source 110. In this position, the longitudinal axis 128 of the power source 110 and the rotational axis 152 of the end effector 150 are concentric such that the engagement members 154 lie in a plane that is substantially parallel to the end wall 118. In the release position, the engagement members 154 of the end effector 150 are located at angular positions between the angular positions of the handling members 124 with respect to the longitudinal axis 128. Put another way, the engagement members 154 lie between the handling members 124 in a circumferential direction with respect to the longitudinal axis 128. Thus, when the end effector 150 is in the release position, the engagement members 154 cannot engage with the handling members 124 when the end effector 150 is moved upwards or downwards relative to the power source 110 and therefore the end effector 150 is free to move upwards away from the power source 110. For example, if the handling members 124 are located at angular positions 0, 90, 180 and 270 degrees with respect to the longitudinal axis 128, then when the end effector 150 is in the release position, the engagement members 154 may be located at angular positions 45, 135, 210 and 315 degrees with respect to the longitudinal axis 128.

FIG. 11B shows the power source 110 and the end effector 150 when the end effector 150 is in an engaged position. In the engaged position, the end effector 150 is at an angular position with respect to the rotational axis 152 such that each engagement member 154 is received by a respective handling member 124, in particular between the retention portion 126 of a respective handling member 124 and the end wall 118 of the power source 110. In the engaged position, movement of the end effector 150 upwards will cause the engagement members 154 to engage with the retention portions 126, which will cause the power source 110 to be lifted by the end effector 150. The engagement between the engagement members 154 and the handling members 124 also allows the end effector 150 to support the weight of the power source 110 so that the end effector 150 can hold the power source 110 in the air and lower the power source 110. The engagement members 154 are also long enough in the radial direction such that they protrude past the outer edge of the end wall 118 of the power source 110.

To move from the release position to the engaged position, the end effector 150 is rotated in a first direction about its rotational axis 152, and to move from the engaged position to the release position, the end effector 150 is rotated in a second, opposite direction about its rotational axis 152. The first direction and the second direction will depend on the arrangement of the handling members 124. For example, if the handling members 124 are configured and arranged to receive the engagement members 154 in an anti-clockwise direction, then the end effector 150 is rotated in an anti-clockwise direction to move from the release position to the engaged position, and the end effector 150 is rotated in a clockwise direction to move from the engaged position to the release position, and vice versa. In the example shown in FIGS. 11A and 11B, the end effector 150 is rotated anti-clockwise from the release position to the engaged position and rotated clockwise from the engaged position to the release position.

To mitigate the risk of the power source 110 slipping off the end effector 150 when being held in the air by the end effector 150, a distal end of the retention portion 126 of each engagement member 154 (i.e. the end of the retention portion 126 opposite to the end which is attached to the support portion 125) comprises a lip 127 extending towards the end wall 118. When the engagement members 154 are engaged with the handling members 124, each engagement member 154 is laterally contained between the support portion 125 and the lip 127 of a respective handling member 124, which helps to prevent the engagement members 154 slipping relative to the power source 110 in a circumferential direction. The vertical distance between each lip 127 and the end wall 118 of the power source 110 may be large enough to allow the engagement members 154 to pass under the lips 127 when rotating between the release position and the engaged position. Alternatively, the vertical distance between each lip 127 and the end wall 118 may be less than the vertical thickness of the engagement members 154 such that the engagement members 154 are required to push past the lips 127 when moving between the release position and the engaged position. In this case, the retention portion 126 may have some resiliency such that the lips 127 are deflected upwards when a torque greater than a torque threshold is applied to the end effector 150 to rotate the engagement members 154 between the engaged position and the release position.

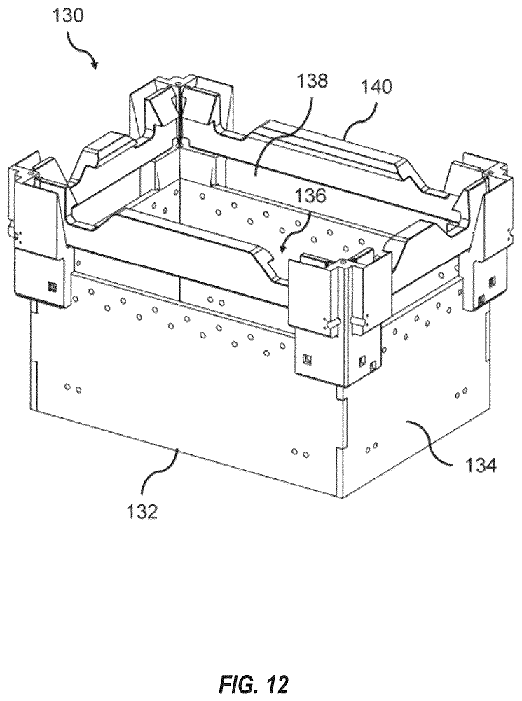

FIG. 12 shows the compartment 130 in insolation. The compartment 130 comprises a base 132 and sidewalls 134 extending from the base 132 define an approximately cuboidal power-source-receiving space 136 for receiving the power source 110 and a compartment opening 138 through which the power source 110 can be inserted into and removed from the compartment 130. As mentioned above, the compartment 130 comprises one or more electrical connectors 139 configured to couple to corresponding electrical connectors 119 on the power source 110 when the power source 110 is inserted into the compartment 130.

The system 100 further comprises a locking assembly for releasably locking the power source 110 in the compartment 130. The locking assembly comprises four locking members 140, each mounted adjacent to a respective side of the power-source¬-receiving space 136. The locking members 140 may be directly or indirectly mounted on the sidewalls 134 of the compartment 130 or on a different supporting structure adjacent to the sidewalls 134. In the illustrated example, the locking members 140 are mounted between corner brackets which are mounted to the sidewalls 134 of the compartment 130. Each locking member 140 is pivotally mounted for rotation about a respective horizontal pivot axis that is parallel to a respective sidewall 134. The locking members 140 are rotatable inwards about their respective pivot axes towards a locked position and outwards about their respective pivot axes towards an unlocked position.

FIG. 13A is a schematic cross-sectional view of the power source 110 within the compartment 130 when the locking members 140 in the locked position and FIG. 13B shows the locking members in the unlocked position. Each locking member 140 comprises an overhang portion 142. In the locked position, the overhang portions 142 overhang the power-source-receiving space 136 such that the power source 110 is blocked from moving upwards out of the compartment 130. In the unlocked position, the overhang portions 142 are vertically clear of the power-source-receiving space 136 (i.e. they do not overhang the power-source-receiving space 136) such that the power source 110 can be lifted out of the compartment 130. Furthermore, each locking member 140 is biased towards the locked position by biasing means 146 such as a spring, e.g. a torsion spring.

Each overhang portion 142 further comprises a tapered surface 144 that slopes downwards towards the base of the compartment 130 such that when a power source 110 is being inserted into the compartment 130, movement of the base 114 of the power source 110 against the tapered surfaces 144 causes the locking members 140 to be pushed outwards against their respective biasing means towards the unlocked position. Thus, the power source 110 can be inserted into the compartment even when the locking members 140 are in the locked position.

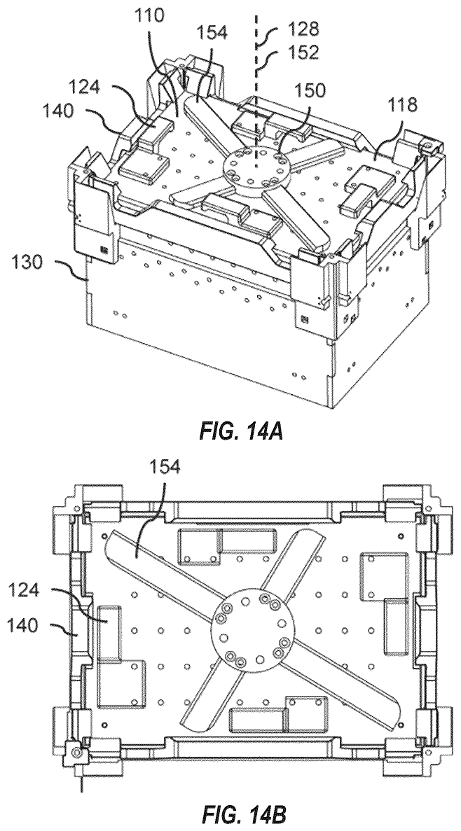

FIG. 14A is a perspective view showing the state of the system 100 when the power source 110 is within the compartment 130 and the end effector 150 is in the release position, and FIG. 14B shows a top view. As explained above, in the release position, the engagement members 154 are located at angular positions between the angular positions of the handling members 124 with respect to the longitudinal axis 128. Furthermore, in the release position, the engagement members 154 are also located at angular positions between the angular positions of the locking members 140 with respect to the longitudinal axis 128 such that the engagement members 154 are not engaged with the locking members 140. Therefore, when the end effector 150 is in the release position, the locking members 140 are in the locked position due to their respective biasing means.

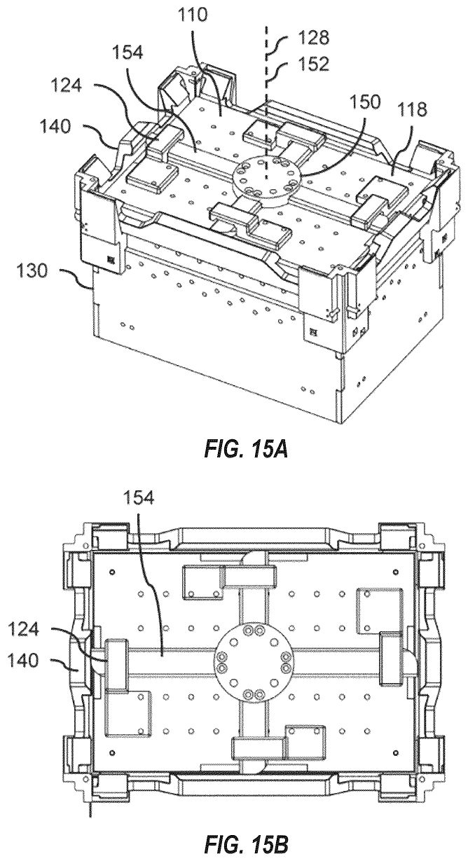

FIG. 15A is a perspective view showing the state of the system 100 after the end effector 150 has been rotated from the release position to the engaged position and FIG. 15B is a top view. As explained above, in the engaged position, the engagement members 154 are received by the handling members 124 in a circumferential direction. Furthermore, in the engaged position, each engagement member 154 is also engaged with a respective locking member 140 such that the locking members 140 are held in the unlocked position against the biasing force of their respective biasing means. In particular, because each engagement member 154 protrudes past a respective outer edge of the end wall 118 in the engaged position, each locking member 140 is pushed outwards far enough so that the overhanging portions 142 no longer overhang the end wall 118 of the power source 110. Therefore, when the end effector 150 is in the engaged position, the locking members 140 are held in the unlocked position and subsequent upwards movement of the end effector 150 will therefore result in the end effector 150 moving (pulling) the power source 110 out of the compartment 130.

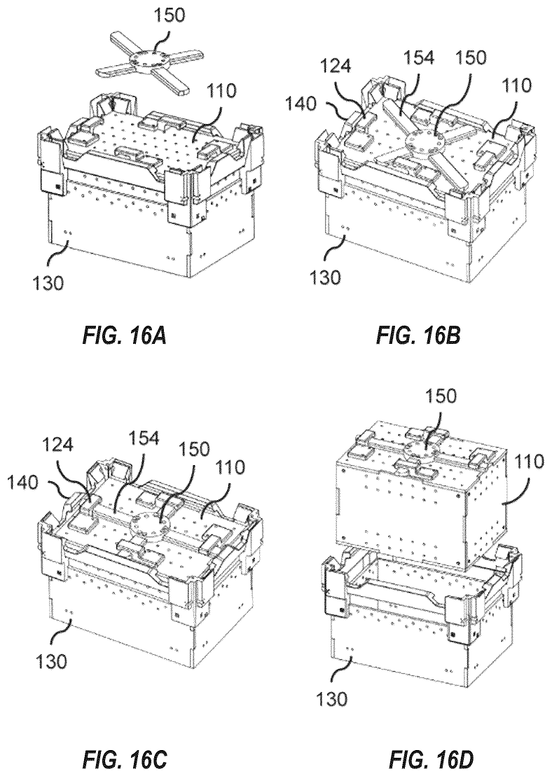

FIGS. 16A-D are a sequence of figures showing how a power source 110 in the compartment 130 can be unlocked and removed using the end effector 150.

In FIG. 16A, the power source 110 is within the compartment 130 and the locking members 140 biased to locked position by the biasing means 146.

In FIG. 16B, the end effector 150 is moved to the release position.

In FIG. 16C, the end effector 150 is rotated about its rotational axis 152 from the release position to the engaged position. This causes the engagement members 154 to simultaneously be received by the handling members 124 and move (push) the locking members 140 from the locked position to the unlocked position.

In FIG. 16D, the end effector 150 is moved upwards to move the unlocked power source 110 out of the compartment 130.

To insert the power source 110 into the compartment 130, the above removal process can be carried out in reverse. In particular, the end effector 150 holds the power source 110 in the engaged position and moves the power source 110 downwards into the compartment 130. Once the power source 110 has been fully inserted into the compartment 130, the end effector 150 rotates from the engaged position to the release position. This causes the engagement members 154 to simultaneously disengage the locking members 140 and the handling members 124, thereby allowing the biasing means to return the locking members 140 to the locked position and allowing the end effector 150 to move upwards away from the power source 110.

To exchange a first power source 110 in the compartment 130 with a second power source 110, the above removal process can be carried out to remove the first power source 110 from the compartment 130 and the above insertion processes can be carried out to insert the second power source in the empty compartment 130. Between the removal the first power source 110 and inserting the second power source 110, the end effector 150 can release the first power source 110 at a location outside the compartment 130 by setting the first power source 110 down and rotating from the engaged position to the release position. The end effector 150 can then pick up the second power source 110 by rotating from the release position to the engaged position with respect to the second power source 110.

The first power source exchange system 100 described above is an example in which the locking members 140 are pivotally rotatable between the locked and unlocked positions. In a variation of the first power source exchange system 100, the locking members 140 could instead be linearly movable between the locked and unlocked positions, together with biasing means (e.g. a spring) for biasing the locking members linearly towards the locked position. Such a variation would function in the same way as the first system 100 to insert, remove and exchange a power source.

The first power source exchange system 100 is also an example in which the compartment 130 comprises the locking members 140, i.e. the moving parts of the locking assembly. In some situations, it may be advantageous for the locking members to be provided on the power source instead of the compartment, as it may be easier and/or cheaper to service the power source instead of the compartment when the locking members need to be serviced or replaced. Some example power source exchange systems in which the power source comprises the locking members will now be described.

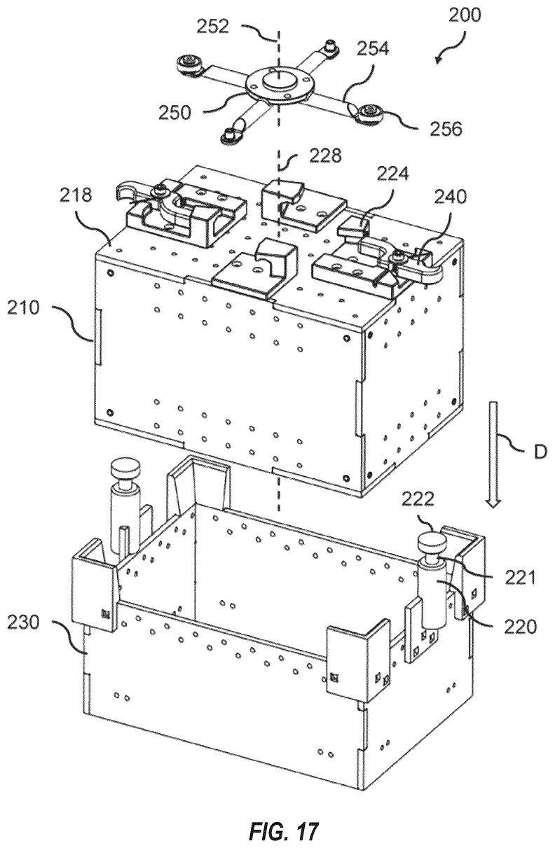

FIG. 17 shows an exploded view of a second power source exchange system 200 comprising a power source 210, a compartment 230 configured to removably receive the power source 210, and an end effector 250 for moving the power source 210 into and out of the compartment 230. The compartment 130 is configured to receive the power source 110 in an insertion direction D, which in this example is a downwards direction. The power source 110 can therefore be removed from the compartment 130 in an upwards direction.

These components of the second power source exchange system 200 are the same or similar to those of the first power source exchange system 100 and therefore, for conciseness, only notable similarities and differences between the two systems will be described below.

The end wall 218 of the power source 210 comprises four handling members 224 having a similar form and arrangement as the handling members 124 of the first system 100, i.e. they are spaced at equal angular intervals about the longitudinal axis 228 of the power source 210, and are configured to receive the engagement members 254 of the end effector 250 in the same circumferential direction.

The end effector 250 has four engagement members 254 arranged in the same way as the end effector 150 of the first example power source exchange system 100, i.e. they are spaced at equal angular intervals about the rotational axis 252 to form a cruciform shape lying in a plane perpendicular to the rotational axis 252 of the end effector 250. The engagement members 254 and the handling members 224 are configured to interact in the same way as the first system 100, i.e. the end effector 250 is rotatable between an engaged position in which the engagement members 254 are received by the handling members 224 for engaging with the handling members 224 to allow the end effector 250 to move the power source 210 into and out of the compartment 230, and a release position in which the engagement members 254 are disengaged from the handling members 224.

The locking assembly comprises two locking members 240 mounted on the end wall 218 of the power source 210. The locking members 240 are diametrically opposed about the longitudinal axis 228 of the power source 210. FIG. 18 shows a close-up view of a locking member 240. Each locking member 240 comprises a shank portion 241 and a hook portion 242 lying in a plane perpendicular to the longitudinal axis 228. The locking members 240 are long enough in the radial direction with respect to the longitudinal axis 228 such that the hook portions 242 extend outwards past the outer perimeter of the end wall 218. Each locking member 240 is pivotally mounted for rotation about a respective pivot axis extending parallel to the longitudinal axis 228. The pivot axis of each locking member 240 is positioned between the end of the hook portion 242 and the end of the shank portion 241 such that the hook portion 242 can be rotated about the pivot axis by moving the end of the shank portion 241 about the pivot axis. The locking members 240 are rotatable in the same direction about their respective pivot axes between a locked position and an unlocked position (i.e. both locking members 240 rotate clockwise from the locked position to the unlocked position and anti-clockwise from the unlocked position to the locked position, or vice versa). Each locking member 240 further comprises biasing means 248 configured to bias the locking member 240 to the locked position. In the illustrated example, the biasing means 248 is in the form of a spring, in particular a torsion spring.

Referring back to FIG. 17, the locking assembly further comprises blocking members 220 for engaging with the locking members 240 in the locked position in order to block the locking members 240, and hence the power source 210, from being moved out of the compartment 230. In particular, the compartment 230 comprises two vertically extending posts 220 mounted adjacent to the power-source-receiving space 236. In this example, the posts 220 are mounted on an opposing pair of sidewalls 234 of the compartment 230; however, they could also be mounted on a structure adjacent to the sidewalls 234. Each post 220 comprises a neck portion 221 and a head portion 222 located on top of the neck portion 221, and the head portion 222 has a larger diameter than the neck portion 221.

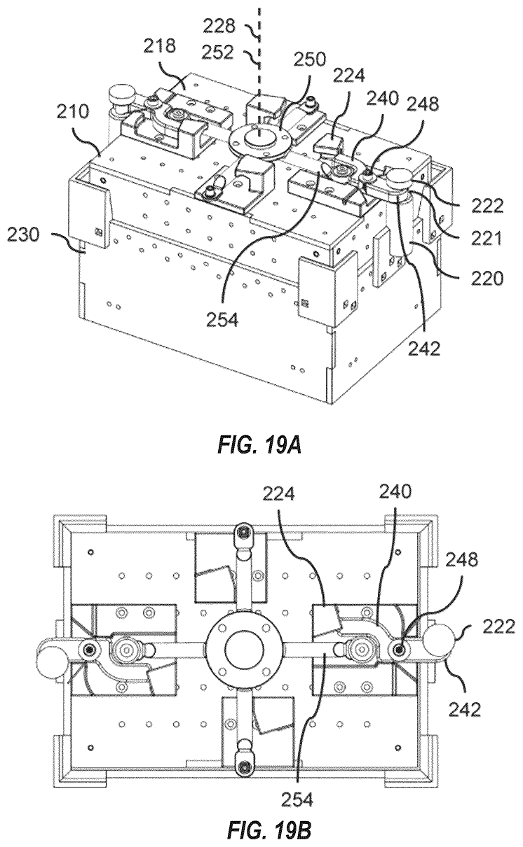

FIG. 19A is a perspective view showing the state of the system 200 when the power source 210 is within the compartment 230 and the end effector 250 is in the release position, and FIG. 19B shows a top view. In the release position, the engagement members 254 are located at angular positions between the angular positions of the handling members 224 and between the angular positions of the locking members 240 with respect to the longitudinal axis 228, i.e. they are not engaged with the handling members 224 or the locking members 240. The locking members 240 are therefore in the locked position due to the biasing means 248. In the locked position, the hook portion 242 of each locking member 240 is engaged with (hooked around) the neck portion 221 of a respective post 220. The diameter of the head portion 222 is large enough such that the head portion 222 blocks the hook portion 242 from moving upwards, which prevents the power source 210 from being moved upwards out of the compartment 230. In particular, the diameter of the head portion 222 may be larger than the distance between two opposing points of the inner surface of the hook portion 242.

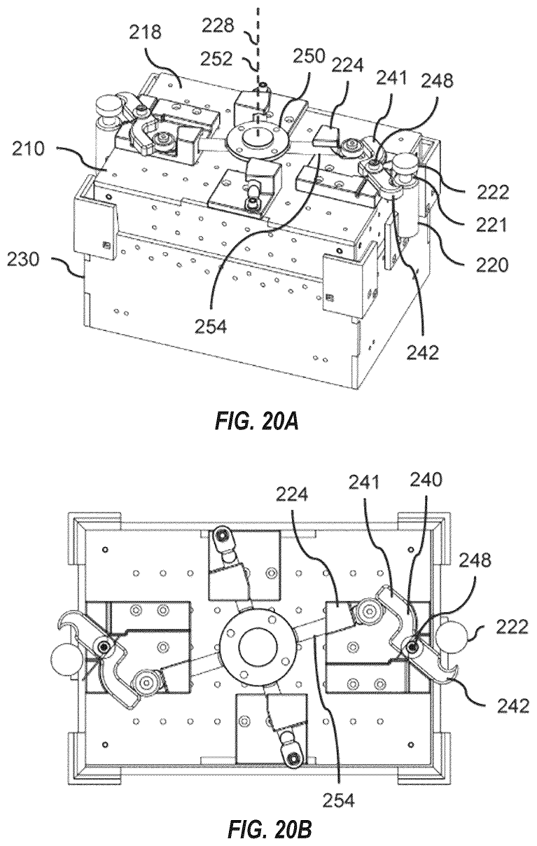

FIG. 20A is a perspective view showing the state of the system 200 after the end effector 250 has been rotated from the release position to the engaged position, and FIG. 20B is a top view. In the engaged position, each engagement member 254 of the end effector 250 is received by a respective handling members 224. Furthermore, in the engaged position, two of the engagement members 254 extending in opposing radial directions are engaged with the locking members 240 such that the locking members 240 are held in the unlocked position against the biasing force of the biasing means 248. In particular, each of the two opposing engagement members 254 have moved (pushed) the shank portions 241 of the locking members 240 against the biasing force of the biasing means 248 such that the hook portions 242 have disengaged (rotated away) from the posts 220. In the unlocked position, the hook portions 242 are vertically clear of the head portion 222 of the posts 220 such that they no longer block the hook portions 242 from moving upwards and therefore subsequent upwards movement of the end effector 250 will result in the end effector 250 moving (pulling) the power source 210 out of the compartment 230.

To remove, insert and exchange a power source 210 using the end effector 250, the same processes described above for the first power source exchange system 100 can be followed. In this example where the power source 210 comprises the locking member 240, it will be appreciated that when the end effector 250 is holding the power source 210 in the engaged position outside the compartment 230, the locking members 240 are held in the unlocked position by the engagement members 254, which allows the end effector 250 to move the power source 210 into the compartment 230 without being obstructed by the posts 220.

To assist the engagement members 254 in moving the shank portions 241 of the locking members 240, each engagement member 254 for engaging a locking member 240 comprises a roller 256 (labelled in FIG. 17) mounted for rotation about a roller axis that is parallel to the longitudinal axis 228. The rollers 256 are configured to engage the shank portions 241 when the engagement members 254 are moving the locking members 240 to the unlocked position.

Although the locking members 240 of the second system 200 are in the form of a hook, the locking members 240 are not limited to this form and may have any shape that extends past the outer edge of the power source 210. The blocking members 220 also do not need to be in the form of a post and may instead have any form which receives the locking members 240 in a circumferential direction with respect to the pivot axis and blocks the locking members 240 from moving upwards. The blocking members 220 could have a form similar to the handling members 224, for example.

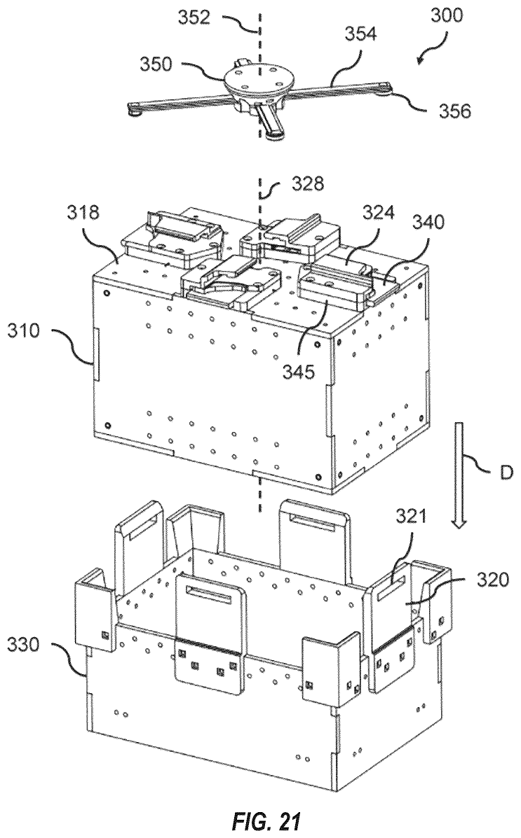

FIG. 21 shows an exploded view of a third power source exchange system 300 comprising a power source 310, a compartment 330 configured to removably receive the power source 310, and an end effector 350 for inserting and removing the power source 310 into and out of the compartment 330 respectively. The compartment 330 is configured to receive the power source 310 in an insertion direction D, which in this example is a downwards direction. The power source 310 can therefore be removed from the compartment 330 in an upwards direction.

These components of the third power source exchange system 300 are the same or similar to those of the first power source exchange system 100 and therefore, for conciseness, only notable similarities and differences between the two systems will be described below.

Whereas the second power source exchange system 200 was an example in which the locking members 240 on the power source 210 pivotally rotate between the locked and unlocked positions, the third power source exchange system 300 is an example in which locking members on the power source move linearly between the locked and unlocked positions.

The end wall 318 of the power source 310 comprises four handling members 324 which have a similar form and arrangement to the handling members 124 of the first system 100, i.e. they are spaced at equal angular intervals about the longitudinal axis 328 of the power source 310, and are configured to receive the engagement members 354 of the end effector 350 in the same circumferential direction

The end effector 350 has four engagement members 354 arranged in the same way as the end effector 150 of the first example power source exchange system 100, i.e. spaced at equal angular intervals about the rotational axis 352 to form a cruciform shape lying in a plane perpendicular to the rotational axis 352. The engagement members 354 and the handling members 224 are configured to interact in the same way as the first system 100, i.e. the end effector 350 is rotatable between an engaged position in which the engagement members 354 are received by the handling members 324 in order to allow the end effector 350 to move the power source 310 into and out of the compartment 330, and a release position in which the engagement members 354 are disengaged from the handling members 324.

The locking assembly comprises four locking members 340 and four guides 345, each locking member 340 and guide 345 being located on the end wall 318, underneath a respective handling member 324. In the illustrated example, the handling members 324 are mounted on the guides 345, but the handling members 324 may alternatively be formed integrally with the guides 344. The locking members 340 and guides 345 are spaced at equal angular intervals about the longitudinal axis 328 (i.e. at 90 degree intervals). The locking members 340 are linearly movable in a direction perpendicular to the longitudinal axis 328. In particular, the locking members 340 are linearly moveable outwards towards a locked position and inwards towards an unlocked position. When a locking member 340 is in the locked position, a portion of the locking member 340 protrudes past a respective outer edge of the end wall 318. When a locking member 340 is in the unlocked position, the locking member is retracted back from the outer edge of the end wall 318 such that it does not protrude past the outer edge.

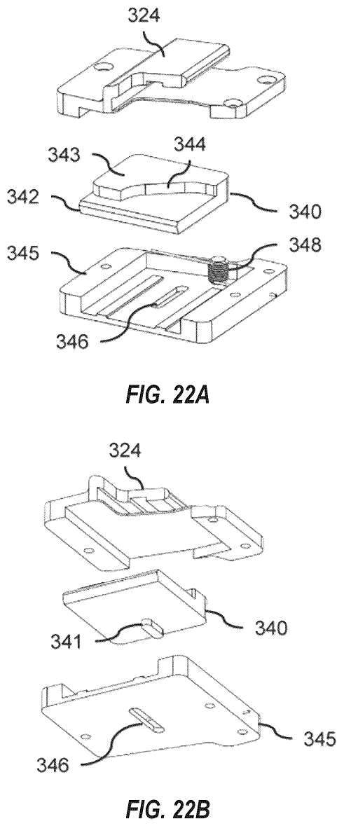

FIG. 22A and FIG. 22B show an exploded view of a handling member 324, a locking member 340 and a guide 345 from above and below respectively.

The handling member 324 and the guide 345 are shaped to define a space in which the locking member 340 sits. The locking member 340 is mounted for linear sliding movement within the guide 344 between a locked position and an unlocked position. The bottom of the locking member 340 comprises a protrusion 341 which is received within a linear slot 346 in the base of the guide 345. The slot 347 and the protrusion 341 are configured to constrain the movement of the locking member 340 to linear movement only. The locking assembly further comprises biasing means 348 in the form of a torsion spring engaged between the locking member 340 and the guide 344. The biasing means 348 applies a biasing force to the locking member 340 to biasing the locking member 340 towards the locked position.

The top of the locking member 340 comprises a raised portion 343 with a side surface 344 that is inclined with respect to the direction of travel of the locking member 340 between the locked and unlocked positions. The side surface 344 is configured to engage an engagement member 354 while the end effector 350 is being rotated from the release position to the engaged position such that the locking member 340 moves inwards to the unlocked position. To facilitate engagement between the engagement members 354 and the side surfaces 344 of the locking members 340, each a roller 356 is mounted on the underside of each engagement member 354 for rotation about an axis parallel to the rotational axis 352. When the end effector 350 is rotated from the release position to the engaged position, each roller 356 engages the side surface 344 of a respective locking member 340 to move the locking members 340 from the locked position to the unlocked position.

Referring back to FIG. 21 the locking assembly further comprises four brackets 320, each mounted adjacent to a respective lateral side of the power-source-receiving space 336. In this example, each bracket 320 is mounted on a respective sidewall 316 of the compartment 330, but they could alternatively be mounted on structures adjacent to the sidewalls 316. Each bracket 320 comprises a slot or recess 321 configured to receive a portion of a respective locking member 340 when the locking member 340 is in the locked position. Each bracket 320 is configured such that once a locking member 340 is within the slot or recess 321, the locking member 340 is blocked from moving upwards, thereby blocking the power source 310 from moving upwards out of the compartment 330. To mitigate any tolerance in the vertical positioning of the locking members 340 and the slots or recesses 321, each locking member 340 comprises a double bevel edge 342 to help the locking member 340 self-locate into the slot or recess 321.

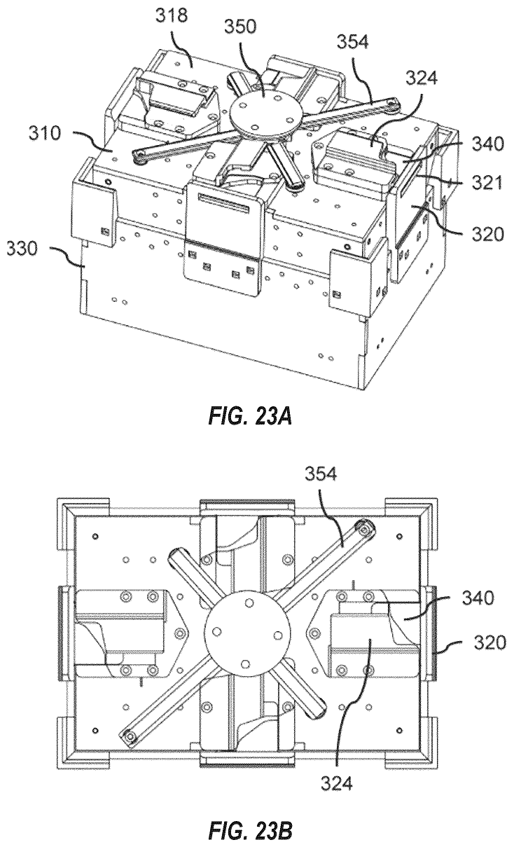

FIG. 23A is a perspective view showing the state of the system 300 when the power source 310 is within the compartment 330 and the end effector 350 is in the release position, and FIG. 23B shows a top view. In the release position, the engagement members 354 are at angular positions between the angular positions of the handling members 324 and between the angular positions of the locking members 340 with respect to the longitudinal axis 328, i.e. they are not engaged with the handling members 324 or the locking members 340. The locking members 340 are therefore in the locked position due to the biasing means 348. In the locked position, the brackets 320 block the locking members 340 from moving upwards, which prevents the power source 310 from being moved upwards out of the compartment 330.

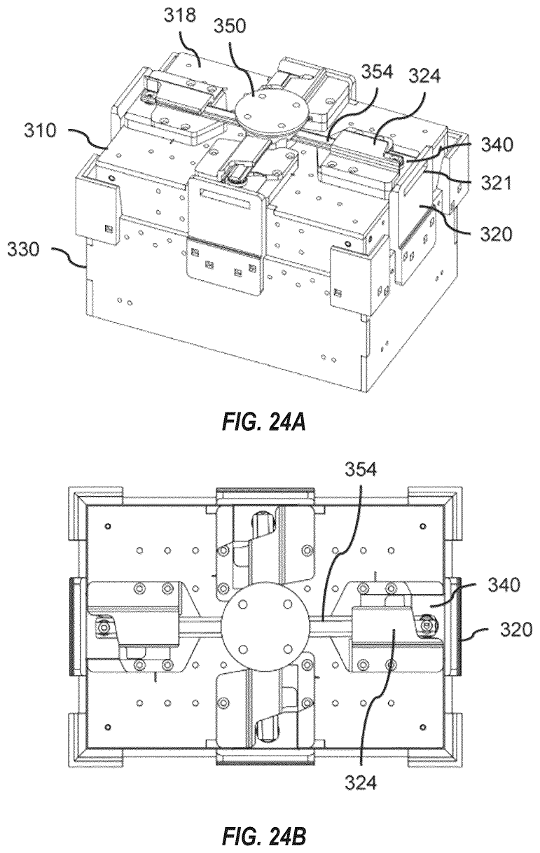

FIG. 24A is a perspective view showing the state of the system 300 after the end effector 350 has been rotated about its rotational axis 352 from the release position to the engaged position, and FIG. 24B is a top view. In the engaged position, each engagement member 354 is received by a respective handling member 324. Furthermore, each engagement members 354 has engaged the side surface 344 of a respective locking member 340 such that the locking members 340 have been moved (pushed) to the unlocked position against the biasing force of the biasing means 348, and are being held at the unlocked position by the engagement members 354. In the unlocked position, the locking members 340 have been retracted out of the slots or recesses 321 of the brackets 320 such that the locking members 340 are no longer blocked from moving in the upwards direction and therefore subsequent upwards movement of the end effector 350 will results in the end effector 350 moving (pulling) the power source 310 out of the compartment 230.

To remove, insert and exchange a power source 310 using the end effector 350, the same processes described above for the first power source exchange system 100 can be followed. In this example where the power source 310 comprises the locking member 340, it will be appreciated that when the end effector 350 is holding the power source 310 in the engaged position outside the compartment 330, the locking members 340 are held in the unlocked position by the engagement members 354, which allows the end effector 350 to move the power source 210 into the compartment 230 without being obstructed by the brackets 320.

The end effector 150, 250, 350 of the power source exchange systems 100, 200, 300 described above may be mounted at the end of a robotic arm for moving and rotating the end effector 150, 250, 350 such that the power source to be inserted, removed, or exchanged in an automated manner. The robotic arm may be, for example, a gantry robot or Cartesian robot in which the end effector can be moved along two or three orthogonal directions (in addition being rotated), or the robotic arm may be an articulated robot comprising rotary joints which can provide greater degrees of freedom, e.g. three, four, five, or six degrees of freedom.

When a power source exchange is to be performed, the compartment 130, 230, 330 and the power source 110, 210, 310 inside or outside the compartment may be located at a predetermined position, or at any one of a plurality of predetermined positions, with respect to the robotic arm such that the robotic arm can be programmed to perform predetermined movements to move and orientate the end effector with respect to the power source to move the power source into or out of the compartment. Alternatively, or in addition, the robotic arm may comprise sensors or a machine vision system to allow the robotic arm to determine the location the power source and the compartment using methods known in the art.

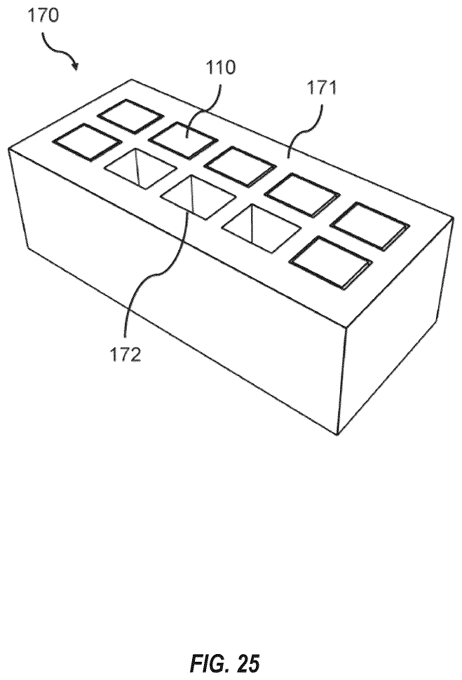

The power source exchange system 100, 200, 300 may further comprise one or more power source stations 170 for storing power sources 110, 210, 310 that have been removed from the compartment 130, 230, 330 and for storing power sources to be inserted into the compartment. FIG. 25 shows an example power source station 170 comprising a plurality of bays 172. Each bay 172 is open to a top surface 171 of the power source station 170 such that each bay 172 can receive a power source in a downwards direction. Each bay 172 may comprise the same locking assembly features as the compartment 130, 230, 330, but given that the power source station 170 will typically be stationary in use, it is not essential for power sources 110, 210, 310 to be locked in the bays 172. The power source station 170 preferably comprises a charging system configured to charge a power source 110, 210, 310 once it has been received in a bay 172. For example, the bays 172 may comprise one or more electrical connectors configured to couple to the electrical connectors 119 on the power source 110, 210, 310 to deliver power from a power supply to charge the power source.

Once the end effector has moved a first power source 110, 210, 310 out of the compartment 130, 230, 330, the end effector 150, 250, 350 may move and release the first power source into an empty bay 172 at the power source station 170. The end effector 150, 250, 350 may then engage a second power source 110, 210, 310 from an occupied bay 172 and move it into the empty compartment 130, 230, 330. In this way, a depleted power source 110, 210, 310 in the compartment 130, 230, 330 can be exchanged with a charged power source 110, 210, 310. The depleted power source 110, 210, 310 can then be charged at the power source station 170 so that it can be used in a future exchange operation.

The use of the power source exchange system 100, 200, 300 in the storage and retrieval system described above allows the power source 110, 210, 310 of the bot 25 to be exchanged in an automated manner while the bot 25 remains on the track structure 13 of the storage structure 1. In particular, one or more robotic arms 50 comprising the end effector 150, 250, 350 can be located on, over, or adjacent to the track structure 13 of the storage structure 1 such that the compartment 130, 230, 330 of one or more bots 25 on the track structure 13 is accessible to the end effector. The track structure 13 may have one or more designated grid cells 14a that are accessible to the end effector, which a bot 25 is required to move to in order to allow the end effector to perform a power source exchange. Once the bot 25 is on a designated grid cell 14a, the compartment may be at a predetermined position with respect to the robotic arm 50, such that the robotic arm 50 can be configured to perform a set of predetermined movements of the end effector to perform the power source exchange.

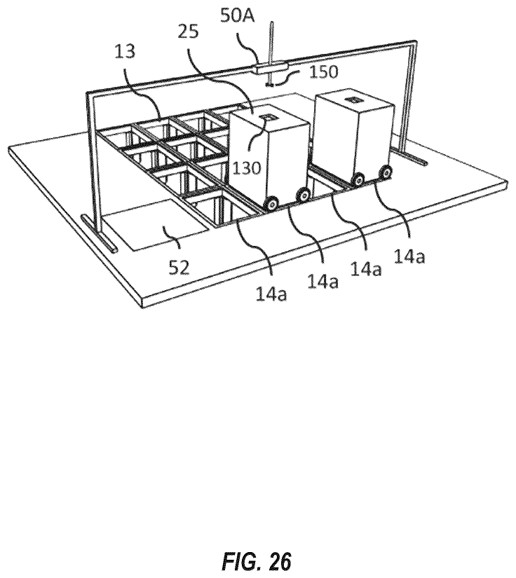

FIG. 26 shows an example robotic arm in the form of a gantry robot 50A in which the end effector is mounted on a gantry extending over a row of designated grid cells 14a of the track structure 13. The illustrated gantry robot 50A is configured to move the end effector in the vertical direction and a first horizontal direction parallel to the row of designated grid cells 14a of the track structure 13 such that the end effector 150, 250, 350 can reach a bot 25 on any one of the designated grid cells 14a in the row. The gantry robot 50A could be further configured to move the end effector in a second horizontal direction perpendicular to the first horizontal direction to allow the end effector to move above a plurality of rows of designated grid cells 14a.

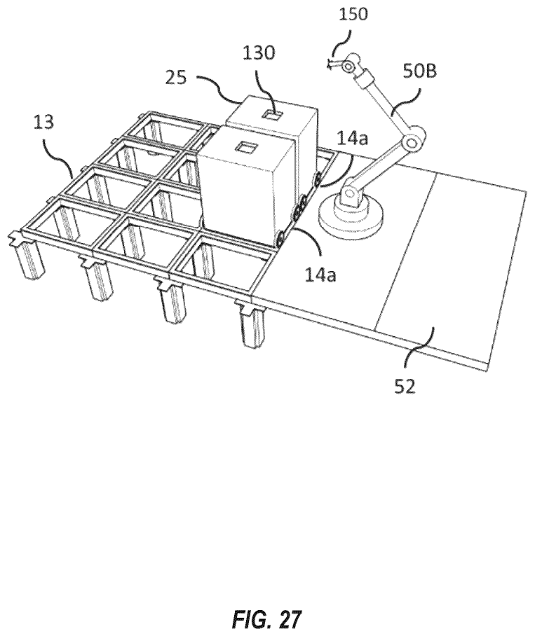

FIG. 27 shows an example robotic arm in the form of an articulated robot 50B located adjacent to the track structure 13 from where the end effector 150, 250, 350 can reach the compartment 130, 230, 330 of a bot 25 on a designated grid cell 14a or one of a plurality of designated grid cells 14a at the edge of the track structure 13. However, the articulated robot 50B could also be located on the track structure 13 itself, e.g. on a grid cell 14, to allow the end effector to reach the compartment of a bot 25 on a designated grid cell 14a or one of a plurality of designated grid cells 14a towards the middle of the track structure 13.

The storage and retrieval system may further comprise one or more power source stations 170 as described above. Each power source storage station 170 may be located in the reachable vicinity of one or more robotic arms 50. For example, a power source station 170 may be located in the region 52 marked in FIG. 26 and FIG. 27 near the track structure 13. A robotic arm 50 may be mounted on the power source station 170 itself, e.g. on the top surface 171.

The storage and retrieval system may comprise a central control system configured to control the movement and functions of the bots 25 on the track structure 13 and activation of the robotic arms 50 to perform power source exchanges. The bot 25 and/or the power source 110, 210, 310 may comprise a power source monitoring system for monitoring the charge level of the power source within the compartment 130, 230, 330. The power source station 170 may also comprise a power source monitoring system to monitor the charge level of the power sources within the bays 172. The control system may use this information to determine: when a bot 25 should move to a designated grid cell 14a to have its depleted power source exchanged; the empty bay 172 into which the robotic arm 50 should place the depleted power source 202; and the occupied bay 172 from which the robotic arm 50 should pick up a charged power source for insertion into the bot 25. When the power source monitoring system indicates that the charge level of the power source is below a predetermined charge level, a controller in the bot may send a signal to the central control system, which commands the bot to travel along a calculated route to a designated grid cell 14a. Once the bot 25 has arrived at the designated grid cell 14a, the bot can confirm its location to the central control system, which can then command a robotic arm 50 to perform a power source exchange. The bot 25 can then resume operation on the track structure 13, while the depleted power source is recharged at the power source station 170. The central control system may communicate wirelessly with the bots 25 and the robotic arms 50 via wireless transmitters and receivers using known wireless communication technologies such as 4G, 5G, Wi-Fi, etc.

The power source exchange system of the present invention is not limited to the precise forms described above and various modifications and variations will be apparent to the skilled person.

For example, the locking assembly is not limited to a particular number of locking members, provided that the power source is sufficiently prevented from moving out of the compartment for a particular use case. Having an opposing pair of locking members so that the power source is secured at two opposing sides (such as the locking assembly in the second system 200) may be advantageous for securely locking the power source in the compartment. Having two pairs of opposing locking members arranged orthogonally to each other (such as the arrangements in the first system 100 and the third system 300) may provide further security.

As shown by the second power source exchange system 200, the number of locking members does not need to be equal to the number of handling members or to the number of engagement members. The number of handling members and the number of engagement members for engaging with the handling members may be chosen to provide sufficient handling stability when the end effector is moving the power source into and out of the compartment, whereas the number of locking members may be chosen to sufficiently secure the power source in the compartment. These different requirements may lead to different numbers of locking members, handling members and engagement members for a particular system. As a result, not all of the engagement members of the end effector may simultaneously be received by a handling member and move a locking member when the end effector is rotated from the release position to the engaged position. Each particular engagement member may be only received by a handling member, or may only move a locking member, or both. It is sufficient for the invention that the end effector as a whole can be received by the handling members and move the locking members when rotated from the release position to the engaged position.

The handling members do not need to be in the form described in the above examples and make take other forms that are suitable for receiving and engaging with a portion of the end effector such that the end effector can engage and move the power source into and out of the compartment. For example, the engagement member may comprise a protrusion and the handling member may comprise a recess that is configured to receive the protrusion in a circumferential direction with respect to the longitudinal axis of the power source when the end effector is rotated from the release position to the engaged position, and engage the protrusion in the vertical direction to allow the end effector to move the power source into and out of the compartment. Alternatively, the handling member may comprise the protrusion and the engagement member may comprise the recess.

The engagement members do not need to be in the form described and illustrated in the above examples and may have any suitable shape, configuration and arrangement for being received by a handling member and/or moving a locking member when the end effector is rotated from the release position to the engaged position.

Although the power-source-receiving space compartment in the above examples is defined by a base and sidewalls, the power-source-receiving space may be a simply be a reserved space within a larger region. The compartment may only be partially defined by a base and/or one or more sidewalls. Furthermore, the base and/or sidewalls do not need to be in the form of solid panels and the base and/or sidewalls of the compartment may instead be in the form of open frames made from corner blocks connected together by connecting elements (e.g. rods), similar to the example external bot body shown in FIG. 8.

Although the example power source exchange systems have been described above with the compartment orientated such that the power source is received in a downwards direction, the power source exchange system is not limited to this orientation of the compartment. In general, the compartment is configured to receive the power source in an insertion direction and any particular directional and orientation terms used in the above description are not limiting, and should be understood as being with respect to the insertion direction. The compartment may be orientated such that the power source is received in a horizontal direction, for example. In this case, the power source would also be orientated such that the previously described end wall of the power source faces a horizontal direction and the rotational axis of the end effector is horizontally orientated for rotation between the engaged position and release position. A power source exchange system with horizontal insertion and removal of the power source may also be used with the bot 25 of the above-described storage and retrieval system. For example, the compartment may be configured to be externally exposed at a lateral side of the external body 27 of the bot 25 such that the compartment is externally accessible to an end effector for allowing the end effector to move the power source into and out of the compartment in a horizontal direction.

The power source exchange system is not limited to being used with the bot 25 described above and may be used with any device that can be powered by an exchangeable power source. The power source exchange system may be used with other forms of load handling devices, vehicles or robots, for example.

The invention thus provides a system in which an exchangeable power source can be securely locked in a compartment and in which an end effector can be used to unlock and remove power source in an efficient and automated manner. The end effector is only required to perform a simple rotational movement to simultaneously unlock the power source and be in a position for engaging the power source to remove the power source from the compartment. The end effector is also only required to perform a simple rotational movement to simultaneously release and lock the power source in the compartment. The end effector is therefore not required to perform any complex gripping movements for engaging and unlocking the power source and therefore a simple and cost-effective end effector can be used.

1. A power source exchange system, comprising:
a compartment configured to removably receive a power source;
an end effector rotatable between an engaged position for engagement with the power source in order to move the power source into and out of the compartment, and a release position; and
a locking assembly comprising a locking member movable between a locked position for blocking removal of the power source from the compartment and an unlocked position for enabling removal of the power source from the compartment,
wherein the end effector and locking assembly are configured such that rotation of the end effector from the release position to the engaged position causes the end effector to move the locking member from the locked position to the unlocked position, and
wherein the compartment defines a power-source-receiving space for receiving the power source and the locking member is configured to overhang the power-source-receiving space in the locked position in order to block removal of the power source from the compartment.

2. The power source exchange system according to claim 1, wherein the compartment comprises the locking member.

3. The power source exchange system according to claim 2, wherein the locking member comprises a tapered surface configured such that movement of the power source into the compartment moves the locking member from the locked position to the unlocked position to allow the power source to be received into the compartment.

4. The power source exchange system according to claim 1, wherein the end effector is configured such that when the end effector is in the engaged position, the end effector extends past the power-source-receiving space to enable the end effector to move the locking member to the unlocked position.

5. The power source exchange system according to claim 1, further comprising:
the power source comprising the locking member, and
wherein the compartment is configured to engage with the locking member when the locking member is in the locked position in order to block removal of the power source from the compartment.

6. The power source exchange system according to claim 5, wherein:
the power source comprises one or more handling members,
each handling member is configured to receive a respective portion of the end effector when the end effector is rotated from the release position to the engaged position, and
the one or more handling members are further configured to engage the respective portion of the end effector to enable the end effector to move the power source into and out of the compartment.

7. The power source exchange system according to claim 1, wherein the compartment is configured to electrically couple to the power source when the power source is received in the compartment.

8. The power source exchange system according to claim 1, wherein:
the locking assembly further comprises biasing means configured to apply a biasing force for biasing the locking member to the locked position, and
the end effector and the locking assembly are further configured such that rotation of the end effector from the engaged position to the release position allows the biasing force to return the locking member to the locked position.

9. The power source exchange system according to claim 8, wherein the end effector and the locking assembly are configured such that when the end effector is in the engaged position, the locking member is held in the unlocked position by the end effector.

10. The power source exchange system according to claim 1, wherein:
the locking assembly comprises a plurality of locking members,
the locking assembly and the end effector are configured such that rotation of the end effector from the release position to the engaged position causes the end effector to move each locking member from the locked position to the unlocked position, and
the end effector comprises a plurality of engagement members arranged such that when the end effector is rotated from the release position to the engaged position about a rotational axis, each particular engagement member moves to a position for engagement with the power source and/or moves one of the locking members from the locked position to the unlocked position.

11. The power source exchange system according to claim 1, wherein the end effector is mounted on a robotic arm configured to move the end effector and rotate the end effector between the engaged position and the release position.

12. The power source exchange system according to claim 1, further comprising:
a power source station comprising a plurality of bays, each bay being configured to receive the power source,
wherein the end effector is further configured to move the power source between the compartment and any of the bays of the power source station,
wherein each bay is configured to charge the power source once received in the bay.

13. The power source exchange system according to claim 1, further comprising:
a load handling device for lifting and moving containers arranged in stacks in a storage structure, the storage structure comprising a track structure, the track structure comprising a first set of tracks and a second set of tracks, the first set of tracks extending in a first direction and the second set of tracks extending in a second direction, the second direction being substantially perpendicular to the first direction, to form a grid pattern defining a plurality of grid cells above the stacks, the load handling device comprising:
a driving assembly configured to move the load handling device on the track structure;
a container-holding device configured to releasably hold a container from above; and
a lifting mechanism configured to raise and lower the container-holding device,
wherein the load handling device comprises the compartment and the compartment is configured to deliver electrical power to one or more electrical or electronic components of the load handling device once the power source is received into the compartment.

14. A power source exchange system comprising:
a compartment configured to removably receive a power source;
an end effector rotatable between an engaged position for engagement with the power source in order to move the power source into and out of the compartment and a release position;
a locking assembly comprising a locking member movable between a locked position for blocking removal of the power source from the compartment and an unlocked position for enabling removal of the power source from the compartment,
wherein the end effector and locking assembly are configured such that rotation of the end effector from the release position to the engaged position causes the end effector to move the locking member from the locked position to the unlocked position; and
the power source comprising the locking member,
wherein the compartment is configured to engage with the locking member when the locking member is in the locked position in order to block removal of the power source from the compartment,
wherein the power source comprises one or more handling members,
wherein each handling member is configured to receive a respective portion of the end effector when the end effector is rotated from the release position to the engaged position, and
wherein the one or more handling members are further configured to engage the respective portion of the end effector to enable the end effector to move the power source into and out of the compartment.

15. A power source exchange system comprising:
a compartment configured to removably receive a power source;
an end effector rotatable between an engaged position for engagement with the power source in order to move the power source into and out of the compartment, and a release position; and,
a locking assembly comprising a locking member movable between a locked position for blocking removal of the power source from the compartment and an unlocked position for enabling removal of the power source from the compartment; wherein the end effector and locking assembly are configured such that rotation of the end effector from the release position to the engaged position causes the end effector to move the locking member from the locked position to the unlocked position,
wherein the locking assembly comprises a plurality of locking members,
wherein the locking assembly and the end effector are configured such that rotation of the end effector from the release position to the engaged position causes the end effector to move each locking member from the locked position to the unlocked position, and
wherein the end effector comprises a plurality of engagement members arranged such that when the end effector is rotated from the release position to the engaged position about a rotational axis, each particular engagement member moves to a position for engagement with the power source and/or moves one of the locking members from the locked position to the unlocked position.

16. The power source exchange system according to claim 15, wherein:
the power source comprises one or more handling members,
each handling member is configured to receive a respective portion of the end effector when the end effector is rotated from the release position to the engaged position,
the one or more handling members are further configured to engage the respective portion of the end effector to enable the end effector to move the power source into and out of the compartment, and
the plurality of engagement members are arranged such that when the end effector is rotated from the release position to the engaged position, each particular engagement member is received by one of the handling members and/or moves one of the plurality of locking members from the locked position to the unlocked position.

17-20. (canceled)
